(19) United States
(12) Patent Application Publication
(10) Pub. No.: US 2004/0039670 A1
(43) Pub. Date: Feb. 26, 2004

(54) Method and system for improving the liquidity of transactions

(76) Inventor: Ka Shun Kevin Fung, Hong Kong (HK)

Correspondence Address: SAWYER LAW GROUP LLP, P O BOX 51418, PALO ALTO, CA, 94303, US

(21) Appl. No.: 10/600,026

(22) Filed: Jun. 19, 2003

Related U.S. Application Data
(60) Provisional application No. 60/389,956, filed on Jun. 20, 2002.

(51) Int. Cl. G06F 17/60

(52) U.S. Cl. 705/35; 705/38

(57) ABSTRACT

A method and system for improving liquidity of transactions for a plurality of contracts is disclosed. The method and system include defining a complete set including the plurality of contracts. The complete set guarantees at least an initial settlement value at at least one particular time. The complete set also corresponds to a settlement value that is determined based upon the initial settlement value. Preferably, the settlement value is determined based upon the initial settlement value and an interest rate effect.

### CROSS-REFERENCE TO RELATED APPLICATION

This application is claiming under 35 USC 119(e) the benefit of provisional patent application serial No. 60/389,956 filed on Jun. 20, 2002.

The present application is related to co-pending U.S. Patent Application Serial No. (2700P), entitled “METHOD AND SYSTEM FOR UTILIZING A SPECIAL PURPOSE VEHICLE FOR IMPROVING THE LIQUIDITY OF TRANSACTIONS” filed on ______. The present application is also related to co-pending U.S. Patent Application Serial No. (2701P), entitled “METHOD AND SYSTEM FOR MANAGING CREDIT-RELATED AND EXCHANGE RELATED RISKS” filed on ______.

### FIELD OF THE INVENTION

The present invention relates to financial instruments, and more particularly to a method and system for improving the liquidity of transactions, preferably using a computer system.

### BACKGROUND OF THE INVENTION

A variety of financial instruments, or contracts, are currently traded in many different markets. These contracts could take a variety of forms and be related to a variety of activities. For example, the contracts could range from options and futures to betting. Participants in the markets place bids (offers to buy contract(s)) and offers (offers to sell contract(s)). Each offer and bid has a price associated. The participants in the market could include individual participants, financial intermediaries, or market makers, such as brokerage houses or banks. Furthermore, the buyers and sellers could be short or long. For example, a long seller is a seller already having a position in the market and holding the contract for which the seller made an offer. A short seller is a seller who does not yet have ownership of the contract being offered for short sale. Similarly, a buyer may be making a bid to cover a contract previously offered for sale. In the case of betting, in buying a contract, a buyer may simply be making a bet. Similarly, a seller of a contract in betting is typically a bookmaker. Systems such as www.betfair.com and www.intrade.com allow customers to buy multiple contracts (bets). Thus, relationships between buyers, sellers, individual participants and market makers may be complex. Furthermore, unnecessary uncertainty may be created in these relationships, which indirectly increases trading costs. In addition, the market in which the participants act could be a traditional exchange, a bookmaking enterprise such as a casino, or other similar market.

Typically, the interaction between the market participants can take place via three conventional structures: conventional order matching, conventional market making, and conventional auctions. In conventional order matching, bids and offers are centralized, typically in an exchange. Individual participants can then buy or sell until an equilibrium for a particular contract is reached. Typically, the exchange takes no risk in the market. In conventional market making, a market maker takes a position opposite to other market participants. Thus, a market maker may sell or buy contracts to other market participants. In conventional auctions, a contract is typically offered for sale to any market participant. Conventional auctions can take a variety of forms. In certain conventional auctions, the contract is initially offered at a high price. The price is progressively lowered until a bid is made and the contract is sold. In conventional Dutch auctions, the lowest price necessary to sell the entire lot of contracts becomes the price at which the contracts are sold.

Regardless of the structures used, the market can be viewed as coming to equilibrium when the prices for all bids for a particular contract are less than prices for all offers for the contract. In other words, no bids are high enough (or conversely no offer is low enough) for a transaction to take place and the contract to be sold. As a result, no more transactions will take place for the contract until a new bid and/or new offer that bridge the gap between the bids and offers is made.

Although conventional structures allow transaction to take place and for the market to come to equilibrium, conventional methods for allowing transactions have drawbacks. First, the conventional structures may not result in a high degree of liquidity. Typically, liquidity can be measured in three ways: bid/offer spread, volume and price discovery. The bid/offer spread is an instantaneous measurement of liquidity. The bid/offer spread is the difference between the highest bid and lowest offer for a particular contract at a particular instant in time. The higher the bid offer spread, the lower the liquidity because the less likely that a market participant will be able to sell or buy the contract. The liquidity can be considered to be the time required to have an order for a contract filled or the volume of transactions for a given unit of time. The shorter the time required to fill an order and the higher the volume of transactions, the greater the liquidity and the easier it would be for a market participant to enter or leave the market. Price discovery is the ability to discover the true price of a contract in the market that has reached equilibrium. The easier it is to discover the price of a contract, the higher the liquidity. Thus, conventional structures such as order matching may result in a higher bid/offer spread, a lower volume of transactions, and more difficulty in determining the actual price of the contracts.

A high liquidity is desirable. A higher liquidity allows the market participants to move in and out of the market more easily. In addition, exchanges desire a high liquidity because exchanges typically obtain a profit based upon the number of transactions carried out. The higher the liquidity is, the higher the number of transactions and the greater the profit of the exchange. Market makers desire a higher liquidity because a high liquidity translates to a higher number of transactions, lower risk for the market maker and a lower cost of borrowing capital for the market maker. Thus, it would be desirable for a higher liquidity in the market place than may be available using the conventional structures for performing transactions.

In addition, the conventional structures of conventional order matching, market making and auctions performed in the conventional manner described above have other drawbacks. Conventional order matching often does not function well when there is an insufficient number of sellers that actually have contract(s) to sell, as opposed to a short seller. As a result, there will be lowered liquidity. In some situations, conventional market makers may actually have an incentive to reduce the competitive nature of the marketplace because the market maker may act to their own advantage, rather than to the advantage of the market as a whole. Conventional auctions take time to set up and identify winner(s).

Accordingly, what is needed is a system and method for addressing the drawbacks of conventional mechanism for allowing transaction to occur. The present invention addresses such a need.

### SUMMARY OF THE INVENTION

The present invention provides a method and system for improving liquidity of transactions for a plurality of contracts. The method and system include defining a complete set including the plurality of contracts. The complete set guarantees at least an initial settlement value at at least one particular time. The complete set also corresponds to a settlement value that is determined based upon the initial settlement value.

According to the system and method disclosed herein, the present invention provides improved liquidity. In particular, the number of transactions relating to the plurality of contracts and the knowledge of price of the plurality of contracts may increase, while the difference between the offer and bid price of the plurality of contracts may decrease. As a result, liquidity is improved.

### BRIEF DESCRIPTION OF THE DRAWINGS

FIG. 1A is a flow chart depicting one embodiment of a method in accordance with the present invention for improving the liquidity of transactions.

FIG. 1B is a block diagram of one embodiment of a system in accordance with the present invention for improving the liquidity of contracts.

FIGS. 2A-2E depict embodiments of sets of contracts and their boundary conditions formed in accordance with the present invention.

FIG. 3 is a more-detailed flow chart depicting one embodiment of a method in accordance with the present invention for improving the liquidity of transactions.

FIG. 4 is a block diagram depicting one embodiment of an exchange window in accordance with the present invention that allows for exchanges with market participants.

FIG. 5 is a block diagram depicting one embodiment of a special purpose vehicle in accordance with the present invention that interacts with market participants.

FIG. 6 is a more detailed flow chart of one embodiment of a method in accordance with the present invention for utilizing the special purpose vehicle to interact with market participants.

FIG. 7 is a block diagram depicting one embodiment of a special purpose vehicle in accordance with the present invention that interacts with market participants.

FIG. 8A depicts a high level flow chart of one embodiment of a method in accordance with the present invention for converting certain financial instruments into a complete set.

FIG. 8B depicts a high level flow chart of one embodiment of a method in accordance with the present invention for converting contract orders into other financial instruments.

### DETAILED DESCRIPTION OF THE INVENTION

The present invention relates to an improvement in transactions involving financial instruments. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown, but is to be accorded the widest scope consistent with the principles and features described herein.

The present invention provides a method and system for improving liquidity of transactions for a plurality of contracts. The method and system include defining a complete set including the plurality of contracts. The complete set guarantees at least an initial settlement value at at least one particular time. The complete set also corresponds to a settlement value that is determined based upon the initial settlement value and, in a preferred embodiment, an interest rate effect, if necessary. In a preferred embodiment, each of the contracts is mutually exclusive of other contracts in the set. Also in a preferred embodiment, the set of contracts is collectively exhaustive of the possible outcomes for the event(s). However, this is not required for all embodiments in accordance with the present invention. The guarantee of settlement value of complete set would still hold. Therefore, special settlement terms will be pre-defined to help distributing the aggregate amount of settlement value to each contract. Such special terms clear any uncertainty arisen from the situation that none of the outcomes described by contract sets occur.

The present invention will be described in terms of particular financial instruments and particular markets or exchanges. However, one of ordinary skill in the art will readily recognize that this method and system will operate effectively for other financial instruments and other market places. The present invention is also described in terms of particular components having certain features. However, one of ordinary skill in the art will readily recognize that the present invention is consistent with additional components and/or different or additional features.

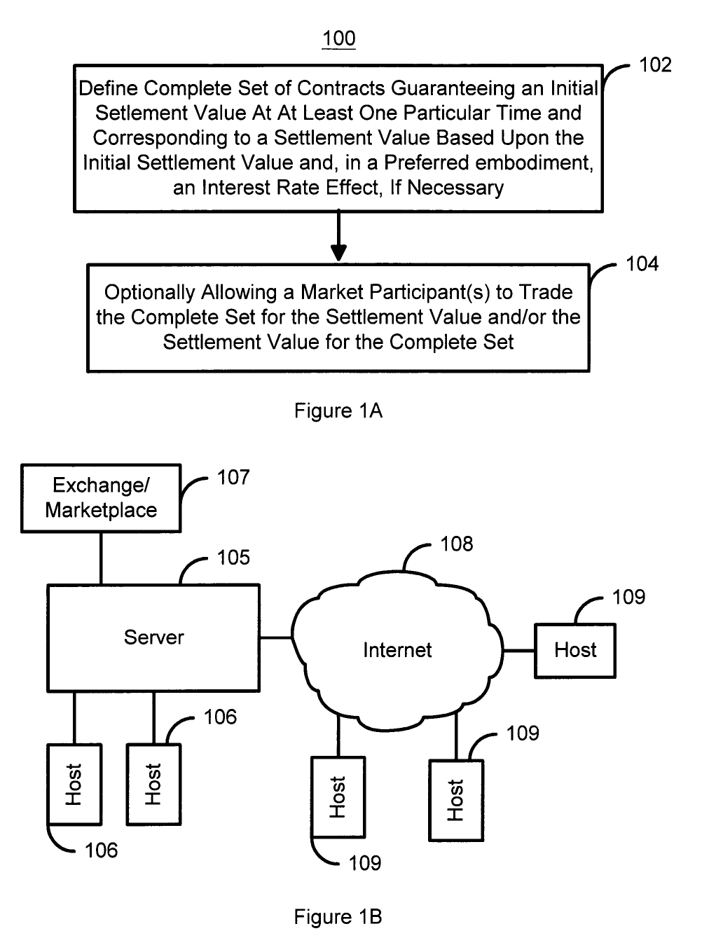

To more particularly illustrate the method and system in accordance with the present invention, refer now to FIG. 1A, depicting a high-level flow chart of one embodiment of a method 100 in accordance with the present invention for improving the liquidity of transactions. In a preferred embodiment, the method 100 is performed at least in part by software used by an exchange, bookmaker, or another financial system or market participant. However, nothing prevents the method 100 from being implemented in another fashion by another entity. The method 100 also preferably allows for transactions to take place after equilibrium would have been established in a conventional manner in the market.

The method 100 preferably deals with the kinds of contracts described above. Each contract in the complete set matures upon a particular event or events and might be traded individually. The contracts could be concerning a wide variety of subjects. Such contracts include but are not limited to options, futures, contracts based on PM pools, contracts based on auction orders and bets. In a preferred embodiment, each contract is discrete. A discrete contract is one which, upon maturing, either wins or loses. Thus, the payment a holder of the contract is due upon maturing is either positive (for a winning contract) or zero (for a losing contract). For example, if the contract is a bet on a particular sporting event, upon expiration of the sporting event, a holder of the contract has either won or lost. Thus, the outcome for such a contract can be considered to be a yes/no or true/false type of outcome. However, the payment amount to which the holder of the contract is entitled may vary. For example, one such contract may entitle its holder to buy a stock by at a particular time for a strike price. The particular time can be considered to be the event upon which the contract matures. If, at the particular time, the stock has an actual price that is higher than the strike price, then the contract wins.

However, the payment amount to which the holder of the contract is entitled may vary. For example, one such contract may entitle its holder to be paid a variable amount conditional upon whether the actual price of the stock is higher than a predetermined price level (the strike price of the call option) at a particular time. The particular time can be considered to be the event upon which the contract matures. If, at the particular time, the stock has an actual price that is higher than the strike price, then the contract wins. However, the total amount that the holder is due depends upon the difference between the actual price of the stock and the strike price of the option. Moreover, such variable amount is usually subject to a predetermined “ceiling” (the capped amount for call spread or capped call option).

A complete set of contracts including a plurality of contracts is defined, via step 102. The complete set of contracts guarantees at least an initial settlement value upon particular time(s) and/or event(s) occurring, preferably upon the contracts maturing. However, the initial settlement value could be determined for another time and/or event. The complete set also corresponds to a settlement value. The settlement value is determined based upon the initial settlement value. In a preferred embodiment, the settlement value is based upon both the initial settlement value and an interest rate effect, if necessary, as described below. In a preferred embodiment, the contracts in the complete set are not only discrete but also mutually exclusive and collectively exhaustive. Because the contracts are collectively exhaustive, all outcomes are represented by the complete set of contracts. However, the contracts in the complete set need not be mutually exclusive and/or collectively exhaustive. In other words, preferably only one contract in the complete set wins upon maturity and all possible outcomes are represented by the complete set of contracts defined in step 102. The step 102 of defining the complete set of contracts also preferably includes monitoring the marketplace or exchange to determine candidates for the complete set. For example, for stock options, candidates for the complete set might include a put spread and a call spread for a particular stock. If the complete set of contracts is based upon sporting event(s), candidates for the complete set include the outcome(s) of the sporting events. If the contracts are for a commodity, then candidates for the complete set include price ranges for the commodity. Based on the candidates found, the complete set can be determined.

In a preferred embodiment, the complete set corresponds to at least the settlement value that is guaranteed regardless of for when the settlement value is determined and regardless of the price of each contract in the complete set. In addition, at least the settlement value is preferably guaranteed regardless of the occurrence of the particular event(s) upon which the contracts' maturing depends. In a preferred embodiment, the initial settlement value and, therefore, the settlement value itself are guaranteed.

However, in an alternate embodiment, the complete set might correspond to an amount greater than the settlement value that might actually be paid to the customer. For example, the settlement value could be an internal value that the customer never actually sees. The exchange or another system is aware of this internal value and understands that at least this amount will be paid to a holder of the complete set. The customer may be provided with a return of an amount greater than the settlement value and never be aware that there is a minimum guaranteed. Thus, a holder of the complete set is entitled to at least the settlement value in exchange for the complete set regardless of the outcome of the individual contracts or whether a particular contract is deemed to win. Furthermore, because the settlement value is preferably guaranteed independent of the occurrence of the event(s) upon which maturation of the contracts depends, the settlement value is preferably guaranteed even in the event that none of the contracts in the complete set is deemed to be a winner. This settlement value is determined and, except for the constant time value of money described below, can be considered to be constant. Thus, the complete set of contracts can be considered to be equivalent to a constant total sum known as the settlement value. Note that although transactions are described herein using the term “holder,” financial instruments such as the complete set and contracts in the complete set can be shorted. Thus, a market participant may be considered to be a holder and might obtain the settlement value, initial settlement value, or other amount by shorting the corresponding financial instrument(s).

In addition to defining the complete set of the contracts, step 102 preferably includes determining the settlement value. In a preferred embodiment, the settlement value can be determined in a variety of ways, typically based upon the price level of the underlying variable that characterizes the possible outcome(s) of the contracts in the complete set at the time the complete set is defined. Thus, the market conditions are preferably used in determining the settlement value. In one embodiment, the settlement value is related to the tick value of the underlying variable. For example, if the complete set of contracts relates to the price of a commodity, such as gold, the settlement value is preferably based upon the price of gold and, preferably, the tick value of the gold. Thus, in order to determine the settlement value in step 102, the exchange or other user of the method 100 would determine what they believe is the value of the complete set of contracts at a particular time. The settlement value, or initial settlement value as discussed below, is based upon the determination of this value.

In a preferred embodiment, the initial settlement value may be adjusted to account for an interest rate effect to determine the settlement value. Thus, the settlement value is determined and it is ensured that the time value of the settlement value is constant. Stated differently, an adjustment in present value may be made to ensure that the value of the settlement value remains constant over time. Consequently, where the settlement value is in money, such as money paid by buyer(s) in transaction(s) occurring in a typical stock exchange that is non-interest-bearing to the buyer(s) concerned, (as opposed to another instrument having a value that automatically adjusts for the interest rate, such as money paid by buyers in transactions occurred in a typical futures exchange that is interest-bearing to buyers concerned), the settlement value is adjusted. In a preferred embodiment, the settlement value is adjusted based upon the initial settlement value determined at the time the complete set is defined. This initial settlement value is preferably realized at a predetermined time, typically when the contract(s) mature due to the occurrence of the corresponding event(s). This predetermined time is termed the reference date. The settlement value is determined based upon the initial settlement value, the time between the exchange of the complete set and the reference date, and the interest rate (which might vary) over that time period. In other words, the settlement value at a particular time can be considered to be the initial settlement value discounted to the particular time. In such a case, monies are preferably deposited in an interest bearing account in order to ensure the constant time value of the settlement value.

To understand the adjustment process for determining the settlement value, the first step is to understand when adjustment is needed, and when not. Simply put, if holding a contract will incur net financing cost (i.e. opportunity cost or interest income forgone) to the contract holder, adjustment will be needed. To illustrate, consider the four common arrangements that may bring different interest rate effects into play:

(i) non-monetary medium of payment—if the medium of payment—price, initial payment and final settlement—is based on instruments that bear no interest income (e.g. mileage points, toy money from games, scores from competition), there is no opportunity cost involved for holding a contract. For example, were the points not “spent” on buying contracts, the points would not generate interest income (even in terms of points) anyway. There is no interest rate effect. Adjustment is not required and settlement value is always equal to initial settlement value. This applies to game-like situation.

(ii) Zero money payment until settlement—if no cash payment is exchanged at the beginning of trade, and over the time of holding the contract, no adjustment is needed even if the final settlement is fulfilled by interest-bearing money (e.g. when contract matures or event outcome determined). This is because there is no financing cost for holding such contract over time. This applies to markets where participants have very high credit quality such as in the inter-bank market.

(iii) Interest-bearing to contract holder—this applies to participants in a typical futures exchange and interest income will be paid to money put in, like bank deposit. There is financing cost to holders as real money is put in. However, such financing cost is compensated and offset by interest income paid by the exchange based on the money put in. The net financing cost is zero. The interest rate effect is neutralized. No adjustment is therefore needed.

(iv) Non-interest-bearing to contract holder—this applies to participants in a typical stock exchange. If a participant buys shares of a particular stock such as IBM, the money put in will not generate interest. Instead the participant may expect cash dividend from IBM stock which is never guaranteed. In such situation, there is interest income forgone (if the money is not used for buying stock, it can be put into bank to generate interest income). Financing cost exists, and therefore interest rate effect prevails. Adjustment is needed.

When adjustment is desired as in situation (iv), a pre-determined payment date (reference date) for the initial settlement value is needed. This is because in such environment money is time sensitive (time value of money). One hundred dollars valued today will be different from one hundred dollars valued two months from today. In a preferred embodiment, the constant total sum (or settlement value) for a complete set is constant over time value when interest rate effect exists. The initial settlement value, once defined with a reference date via step 102, enables many of the benefits achieved by the method and system described herein. At any time, the settlement value is the present value of initial settlement value, which is represented by

SV=initial settlement value/(1+interest rate over the period)^{t}

Where:

SV=settlement value

t=time

Such present value calculation is common in finance and would be appreciated by one skilled in the art.

Note that interest rate may vary depending on whether money is needed to buy the complete set (borrow rate for interest rate), or money be received on selling (short) the complete set (lending or deposit rate for interest rate). Therefore, one may interpret the settlement value as having bid and offer side. The interest rate will also be different depending on credit quality and funding cost of the relevant trading entity. Also, for some trading entities they may choose to set interest rate at zero at certain situation, say, on selling complete set, to fully absorb any benefit from interest rate effect. Alternatively, an entity may choose only to short sell a complete set, assuming interest rate equal to zero, and buy complete set subsequently only as a buy-back of previously sold contracts.

Given that the relevant interest rate can be assumed to be non-negative, initial settlement value will be greater than or equal to settlement value. There may be exceptional situation when the event is delayed. For payment beyond reference date, adjustment is needed to compensate for the financing cost incurred to holders from reference date to the delayed date. Contract holders will therefore either be paid for such amount as interest income, or paid through settlement value which will be adjusted upwards. Therefore settlement value will be higher than initial settlement value in such exceptional situation.

On the other hand, if the event is determined before reference date (i.e. the contract matures before the reference date), relevant payment is still preferably paid on reference date. The reference date is the relevant date for the initial settlement value. Stated differently, the initial settlement value is what is payable on the reference date. Therefore contract holders, even those having their payment amount (if any) confirmed before the reference date, would still wait until reference date to “cash in” the contract for the initial settlement value. Alternatively, contract holders may be given a choice to redeem the contract value before reference date at the settlement value (early redemption). In such a case, the initial settlement value is discounted to calculate the settlement value. The early redemption may be executed through market operations. In a preferred embodiment, the early redemption is through the exchange or a dedicated entity bidding for the contract at the market with a bid price equal to the settlement value (or present value of initial settlement value), minus all relevant costs such as administrative costs.

Each contract in the complete set defined in step 102 preferably matures upon the same event(s) occurring. Preferably, the contract(s) mature upon the reference date. However, nothing prevents the contracts from maturing upon different events. In addition, the complete set is preferably mutually exclusive. If one contract in the complete set is a winning contract, no other contract in the complete set will be a winning contract. However, there may be exceptions to the contracts being mutually exclusive, as is discussed below with respect to certain boundary cases. The contracts in the complete set may relate to a particular range of a variable. In such a case, step 102 could include determining which contract(s) are winning contracts at boundaries between the ranges. For example, each contract may be for a return if the price of a particular stock is within a range. For example, the complete set may include four contracts. The first contract, Contract A, would provide a first return if the stock price is less than $300 at a particular time. The second contract, Contract B, would provide a second return if the stock price is between $300 and $350 at a particular time. The third contract, Contract C, would provide a third return if the stock price is between $350 and $400 at the particular time. The fourth contract, Contract D, would provide a fourth return if the stock price is greater than $400 at the particular time. Thus, the boundaries are at $300, $350, and $400. The winning contract(s) at a boundary could be determined in a variety of ways. In one embodiment, one and only one contract could be determined to be the winner at a boundary. For example, the first contract would provide a return if the stock price is less than or equal to $300 at the particular time, while the second contract would not provide a return if the stock price was equal to $300 at the particular time. In another embodiment, multiple contracts could be determined to be the winner at the boundary, with the winnings split in a particular fashion.

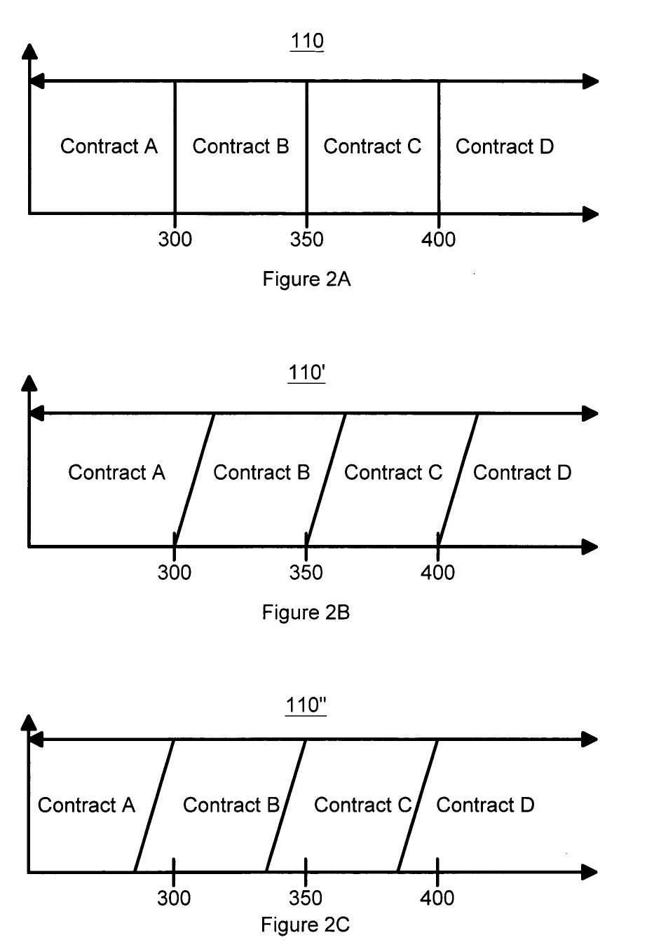

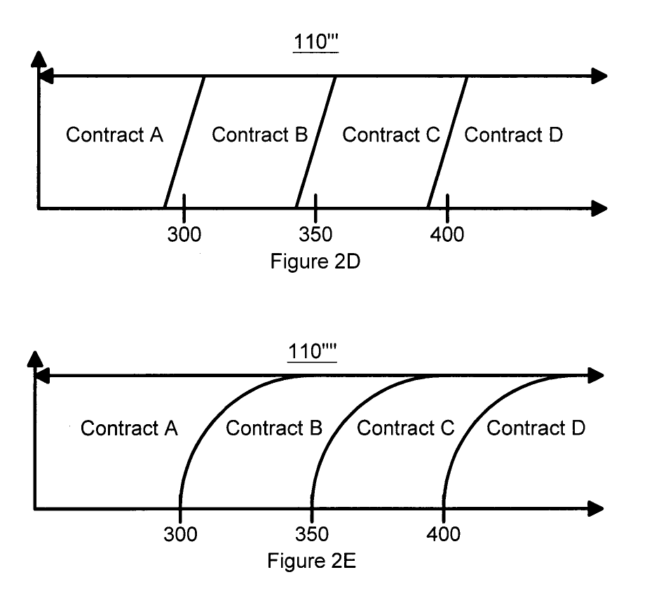

FIGS. 2A-2E depict embodiments of a set of contracts in the example above and their boundary conditions formed in accordance with the present invention. In each graph 110, 110′, 110″, 110′″, and 110″″ the horizontal axis is the variable upon which the contracts depend and the vertical axis is the return for a particular contract. FIG. 2A depicts the case 110 in which the boundaries are defined so that only one contract is the winner. Alternatively, the vertical boundary can be defined such that if the variable settles at exactly the boundary the settlement value will be split, for example 50:50, between the two contracts. FIG. 2B depicts a graph 110′ using a “bull” slope, replacing vertical boundaries. The size of the slope (steepness of the boundaries) is preferably set based upon market conditions. Thus, in the region near the boundaries $300, $350, and $400, there may be multiple winning contracts, with the payout to each contract depending upon the proximity to the boundaries. FIG. 2C depicts a graph 110″ using a “bear” slope, replacing vertical boundaries. The size of the slope (steepness of the boundaries) is preferably set based upon market conditions. Thus, in the region near the boundaries $300, $350, and $400, there may be multiple winning contracts, with the payout to each contract depending upon the proximity to the boundaries. FIG. 2D depicts a graph 110′″ using a “neutral” slope, replacing vertical boundaries. Thus, at the boundaries $300, $350, and $400, there are two winning contracts, with the payout to each contract being equal. FIG. 2E depicts a graph 110″″ that uses curves to determine payout at and near the boundaries $300, $350, and $400. Although FIGS. 2A-2E depict how boundary conditions may be handled, nothing prevents the boundaries from being treated in a different manner. However, referring back to FIG. 1A, in defining the complete set in step 102, the boundaries between contracts in the complete set should be accounted for. Furthermore, if the complete set includes a digital put and a digital call, step 102 preferably includes determining the boundaries between the digital put and digital call around the strike price so that the digital put and digital call can be assembled to a single complete set that matures upon a single event, the maturity of the option. Intuitively, contracts may be designed such that they are mutually exclusive at boundary condition. However the winning of two contracts is allowed (e.g. 50:50 split on settlement value).

One or more market participants are optionally allowed to obtain the settlement value in trade for the complete set and vice versa, via step 104. Note that the complete set could be shorted in step 104. In a preferred embodiment, step 104 would also allow market participant(s) to obtain the complete set of contracts in exchange for the settlement value. Consequently, the condition required to be met in order to obtain the settlement value is that the market participant(s) hold the complete set. Although a single market participant can hold the complete set, in a preferred embodiment multiple market participants which together hold the complete set can form a group. As long as the group holds the complete set, the group can exchange the complete set for the settlement value. For example, if a complete set consists of four contracts, a first market participant might hold the first contract, a second market participant might hold the second and fourth contracts, and a third market participant might hold the third contract. The three market participants could form a group which, as a group, could exchange the complete set for the settlement value.

In a preferred embodiment, step 104 allows market participants to trade the complete set of contracts for the settlement value at any time, and vice versa. However, in another embodiment, step 104 only allows the market participants to exchange the complete set of contracts for the settlement value upon maturity of the contracts (or, preferably, in the event that the contracts in the complete set do not mature). Also in a preferred embodiment, step 104 allows a market participant to pay the settlement value and obtain the complete set at any time. However, in an alternate embodiment, there may be restrictions on when market participants can exchange the settlement value for the complete set.

In one embodiment of step 104, the settlement value provided in exchange for the complete set is provided in cash. However, in alternate embodiments, cash need not be used. For example, the settlement value can be paid in goods or a negotiable instrument particular to the exchange in which the transaction is made. Payment in such a negotiable instrument would secure greater loyalty of the market participant to the exchange because the settlement value could only be used in transactions in the exchange. In addition, profits for the exchange could improve because of the increased number of transactions.

Step 104 can also include presenting information to market participants in a particular manner, called order slicing, to allow market participants to better decide whether to use step 104 to exchange the complete set for the settlement value or vice versa. In a preferred embodiment, the information is provided in a matrix that matches each plurality of contracts with any bid or offer for each plurality of contracts. In addition, the bids and offers are preferably ranked in order based upon the price of the bid or offer. For example, the columns in the matrix would correspond to the contracts. The rows would correspond to the offers or bids, preferably ranked from highest to lowest. Thus, for example, a market participant could rapidly understand whether the sum of the bids for a complete set is greater than the settlement value. Similarly, a market participant could rapidly understand whether the sum of the offers for a complete set is less than the settlement value. A market participant could thus more easily make decisions on whether to buy contracts in the complete set, sell contracts in the complete set, exchange the complete set for the settlement value, or exchange the settlement value for the complete set.

Using the method 100, liquidity can be improved beyond the equilibrium established using conventional mechanisms. For example, equilibrium may be established in a conventional manner. As a result, all bids would be less than all offers for the contracts in a complete set. However, the sum of the bids for the contracts in the complete set may be greater than the settlement value. In such a case, a market participant or another entity may understand that the value of the contracts (the initial settlement value and/or the settlement value) is greater than the cost of the complete set. Thus, the market participant or other entity might obtain the complete set in exchange of the settlement value. The contracts in the complete set could then be sold individually to each bidder to obtain a profit. Similarly, if the sum of the offers for the contracts in a complete set is less than the settlement value, then market participant or another entity would use the offers to individually buy the contracts. The complete set could then be exchanged for the settlement value (or the initial settlement value at the appropriate time) and a profit obtained. In addition, while having knowledge of the complete set, market participants or other entities might buy or sell contracts in the complete set, or the complete set itself, even when there is no profit to be made immediately. Thus, using the information relating to the complete set and contracts therein, market participants or other entities could buy and/or sell contracts when they otherwise would not make any trades. As a result, more transactions would take place.

FIG. 1B is a block diagram of one embodiment of a system in accordance with the present invention for improving the liquidity of contracts. The system includes a server 105 that implements at least a portion of the method 100. The server 105 is coupled with the exchange or marketplace 107. Although depicted as directly connected to the server 105, the data for the exchange/marketplace 107 may be obtained through the Internet 108. The server 105 may also be coupled to hosts 106 through a network and, via the Internet 108, to hosts 109. The server 105 preferably monitors the exchange/marketplace 107 to determine candidates for the complete set of contracts as well as obtain information related to the price of the contracts. The server 105 preferably defines the complete set and settlement value in step 102. In addition, the server 105 can transmit information, such as the contracts in the complete set and the settlement value, to the exchange/marketplace 107. Complete set(s) of contracts may thus be traded through the exchange/marketplace 107. Furthermore, the server 105 may transmit such information to the hosts 106 and/or 109. The hosts 106 and/or 109 may thus be used by market participants to obtain information about the complete set(s) of contracts and to buy and/or sell contracts in the complete set. In addition, one or more of the hosts 106 and/or 109 may be used by authorized individual(s) to configure and control the server 105. Thus, the method 100 may be implemented using the system depicted in FIG. 1B.

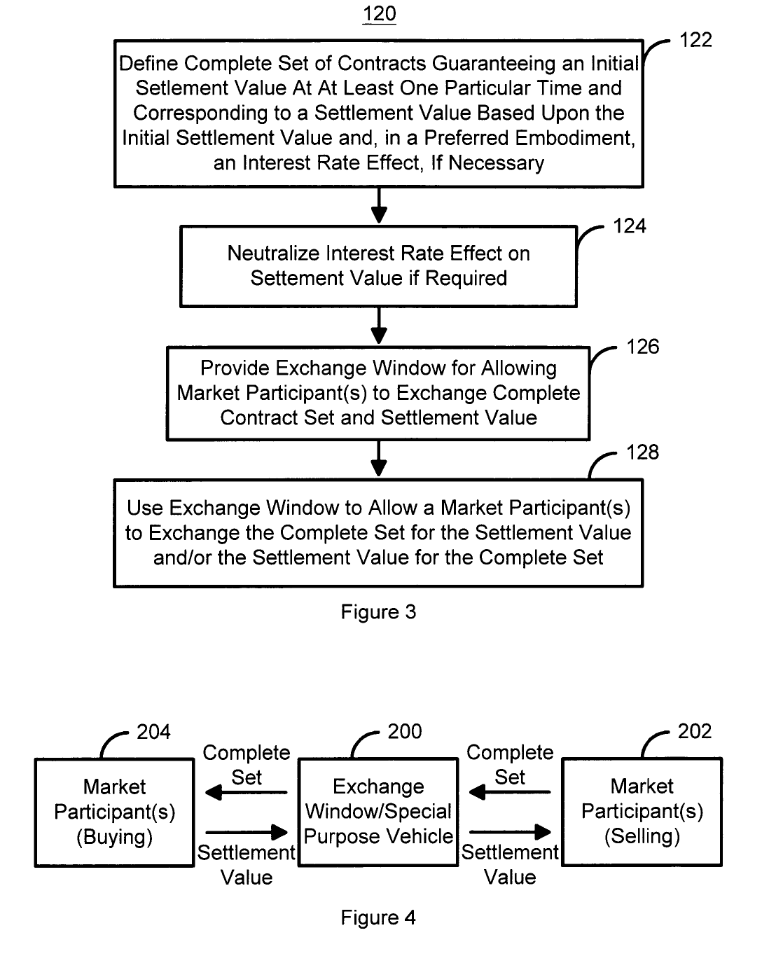

FIG. 3 is a more-detailed flow chart depicting one embodiment of a method 120 in accordance with the present invention for improving the liquidity of transactions. In a preferred embodiment, the method 120 is performed at least in part by software used by an exchange, bookmaker, or another financial system or market participant. However, nothing prevents the method 120 from being implemented in another fashion by another entity. The method 120 preferably deals with the kinds of contracts described above with respect to the method 100. Consequently, the method 120 preferably includes but is not limited to the aspects of the method 100 described above.

Referring back to FIG. 3, the complete set of contracts is defined, via step 122. Step 122 is analogous to step 102. Consequently, step 122 is not separately discussed. The interest rate effect is accounted for to ensure the constant time value of the settlement value, via step 124. For example, the settlement value, guaranteed for a complete set on a predetermined future date, will be discounted back into present value with reference to the date that exchange window is accessed. Thus, the initial settlement value at a predetermined future date, the time that the exchange window is accessed, the interest rate, and the predetermined future date are used in discounting to the present value to account for the interest rate effect. Step 124 preferably includes depositing sums in an interest bearing account when required in order to account for the interest rate effect and ensure the constant time value of the settlement value. For example, if the contracts involve futures, a market participant's call monies could be deposited in the interest bearing account. However, the interest rate effect could be neutralized in another manner. In addition, in some cases, for example where goods or another type of negotiable instrument is used in lieu of cash, the interest rate effect need not be accounted for.

An entity called an exchange window is provided, via step 126. In a preferred embodiment, the entity could also be termed a special purpose vehicle. However, in a preferred embodiment, the special purpose vehicle could have additional functions. For example, in a preferred embodiment, the special purpose vehicle could monitor the market and automatically trades complete sets of contracts or individual contracts in the complete set based upon the status of the market. Consequently, for simplicity, only the term exchange window is used in conjunction with the method 120. The exchange window is preferably provided by the exchange, or perhaps a market maker. However, the exchange window could be provided by a different entity. Thus, in step 128, the exchange window is used to allow market participant(s) to exchange the complete set of contracts for the settlement value or vice versa. Step 128 is thus analogous to step 104 of the method 100 depicted in FIG. 1A. Referring back to FIG. 3, in one embodiment, the exchange window also accounts for the interest rate effect in step 124. In addition, the exchange window may account for the interest rate effect using any profits obtained from buying and selling complete sets. Furthermore, the exchange window may automatically notify selected market participant(s) when it is profitable to assemble the complete set for exchange or obtain the complete set for individual sale. Furthermore, the exchange window might allow market participants to exchange one contract for another.

FIG. 4 is a block diagram depicting one embodiment of an exchange window 200 in accordance with the present invention that allows for exchanges with market participants. The market participants 202 are allowed to turn in the complete set of contracts to obtain the settlement value from the exchange window 200. The market participants 204 are allowed to pay the settlement value at the exchange window 200 and receive the complete set of contracts from the exchange window 200. Note that the settlement value received or provided by the exchange window could be in cash, goods, or another negotiable instrument as defined above. In addition, the exchange window 200 can sell/buy the complete set from individual market participants 202/204 or from groups of market participants 202/204. Referring to FIGS. 3 and 4, in a preferred embodiment, the exchange window 200 provided in step 126 is also available when the market is not open for business.

Thus, the exchange window 200 can be an additional mechanism for market participants to perform transactions. The exchange window provides a mechanism for market participants to obtain the settlement value and/or the complete set of contracts. Thus, using the method 120 and the exchange window 200, liquidity can be improved beyond the equilibrium established using conventional mechanisms. For example, equilibrium may be established in a conventional manner. As a result, all bids would be less than all offers for the contracts in a complete set. However, the sum of the bids for the contracts in the complete set may be greater than the settlement value. In such a case, a market participant may obtain the complete set from the exchange window 200 in exchange for the settlement value. The contracts in the complete set could then be sold individually to each bidder to obtain a profit. Similarly, if the sum of the offers for the contracts in a complete set is less than the settlement value, then a market participant or another entity would use the offers to individually buy the contracts. The complete set could then be exchanged at the exchange window 200 for the settlement value and a profit obtained. As a result, more transactions would take place and liquidity would be improved. In addition, profits for the exchange would improve because of the increased number of transactions.

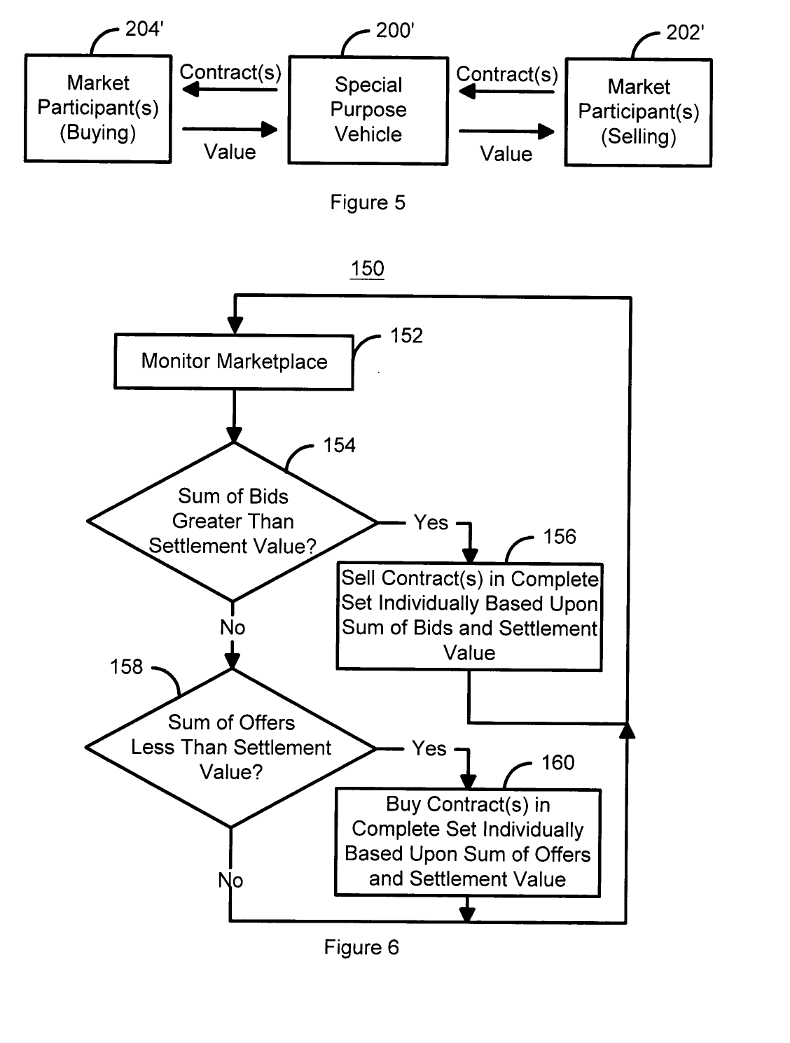

FIG. 5 is a block diagram depicting one embodiment of a special purpose vehicle 200′ in accordance with the present invention that interacts with market participants. In one embodiment, the special purpose vehicle 200′ is provided by the exchange or market maker. However, another entity can provide the special purpose vehicle 200′ and enjoy the benefits achieved. The special purpose vehicle 200′ interacts with market participants 202′ and 204′. The special purpose vehicle 200′ obtains contracts from market participants 202′ in exchange for value. The value could take the form of, for example, cash, goods, or a negotiable instrument. In some cases, the special purpose vehicle 200′ obtains the complete set of contracts from the market participants 202′ in exchange for the settlement value. The special purpose vehicle 200′ sells contracts to the market participants 204′ for value. Again, the value could take the form of, for example, cash, goods, or a negotiable instrument. In one embodiment, the special purpose vehicle 200′ provides market participants with a complete set in exchange for the settlement value. Note that the value received or provided by the special purpose vehicle 200′ could be in cash, goods, or another negotiable instrument as defined above. The special purpose vehicle 200′ preferably has the same abilities as the exchange window 200. Thus, the same benefits as for the exchange window 200 could be enjoyed using the special purpose vehicle 200′. In addition, the special purpose vehicle can make trades automatically, can assemble a complete set, and obtain its own profit.

FIG. 6 is a more detailed flow chart of one embodiment of a method 150 in accordance with the present invention for utilizing the special purpose vehicle 200′ to interact with market participants 202 and 204. In a preferred embodiment, the method 150 is performed at least in part by software used by an exchange, bookmaker, or another financial system or market participant. However, nothing prevents the method 150 from being implemented in another fashion by another entity. The method 150 preferably deals with the kinds of contracts described above with respect to the methods 100 and 120. Consequently, the method 150 preferably includes but is not limited to the aspects of the methods 100 and 120 described above.

The special purpose vehicle 200′ monitors the market, via step 152. It is determined, based on the information obtained in step 152, whether the sum of the bids for individual contracts in a complete set meets certain criteria, via step 154. Preferably, step 154 determines whether the sum of the bids for individual contracts in a complete set is greater than the settlement value, via step 154. Step 154 could be performed using order slicing, described above. As a result, the special purpose vehicle 200′ can rapidly determine whether to sell contract(s), which contract(s) to sell, and how many contract(s) to sell. If the sum of set(s) of bids is greater than the settlement value, then the special purpose vehicle 200′ can individually sell one or more complete sets of the contracts (or portion of the complete set) to the market participants, via step 156.

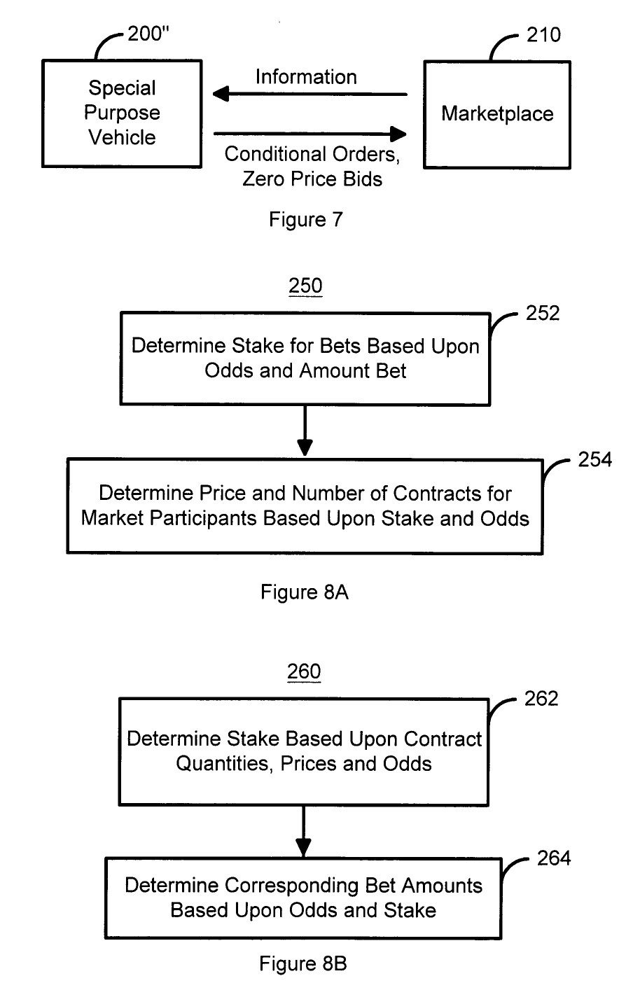

For example, in one embodiment, the special purpose vehicle 200 might sell a portion of the complete set assuming that one or more of the contracts might be bought at a price of zero. FIG. 7 is a block diagram depicting one embodiment of a special purpose vehicle 200″ in accordance with the present invention for using a special purpose vehicle that interacts with market participants in such a situation. Suppose a complete set composed of C1, C2 and C3. Further suppose there is no bid/offer for C1 and only one bid each for C2 and C3, each of quantity one in the marketplace 210. Thus, the situation in the marketplace 210 is:

| Type | Contract C1 | Contract C2 | Contract C3 |
|---|---|---|---|
| Bid | | 70 | 30 |
| Offer | | | |

The sum of the bids for C2 and C3 is 100. The special purpose vehicle 200″ could assume as if there was a market bid available for C1 at a price of $0 and quantity of one. Note, however, that the zero price bid could be assumed for any contract and for any quantity to facilitate trading. Stated differently, the contract C1 could be assumed to effectively be bought for a price of zero. The special purpose vehicle 200″ may, therefore, be able to sell the complete set for greater than or equal to the settlement value. Because further transactions may take place, liquidity would still be improved. In addition, after the trade the special purpose vehicle 200″ has the capacity to sell one unit of C1 in the future at effectively any desired price (greater than or equal to zero), because such a contract is effectively bought at zero price (from the zero price bid). Such sale action for C1 in the future will also improve liquidity of C1. Alternatively, the special purpose vehicle 200″ can unwind the position subsequently in the market by buying C2 and C3 only (rather than a complete set) for less than or equal to the settlement value. This will improve liquidity of C2 and C3.

Note that the process can also accommodate bids of combination orders. A combination order means either all or nothing of the specified group of orders is executed. For example, suppose a complete set composes of C1, C2 and C3 and there is a combination order (Order No. 1) to buy (one of C2, and two of C3). Such a combination order will only be executed as a group together or will not executed be at all. Thus, there will not be the case that some of C2 is bought without buying any of C3, and vice versa. Thus, if there are other orders for buying one of C1 (Order No.2) and for buying a combination (one of C1, one of C2) (Order No.3), these two orders (Order No. 1 and 2) can come together with the combination order number three to form two complete sets. The aggregate price limit of the three orders will be computed to see if it is equal to or greater than two times the settlement value.

Referring back to FIG. 6, note that the special purpose vehicle 200′ may have previously obtained the complete set sold in step 156 by paying market participant(s) the settlement value. The special purpose vehicle 200′ might also short the contracts in the complete set. In addition, in a preferred embodiment, the special purpose vehicle 200′, possibly enabled by the information technology, such as the computer and trading systems, of the exchange, may secure the trades at essentially a single moment in time for all of the contracts sold in step 156. As a result, the legging risk can be substantially reduced or eliminated. Otherwise, the special purpose vehicle 200′ determines, based upon the information obtained in step 152, whether the sum of the offer prices meets particular criteria, via step 158. In one embodiment, it is determined in step 158 whether the sum of the offer prices is less than the settlement value. In another embodiment, step 158 determines whether the sum of the offer prices is less than or equal to the settlement value, via step 158. Step 154 could be performed using order slicing, described above. As a result, the special purpose vehicle 200′ can rapidly determine whether to buy contracts, which contracts to buy, and how many contracts to buy.

Based upon the sum of the set(s) of offers, the special purpose vehicle may assemble one or more of the complete set(s) of contracts, via step 160. In one embodiment, if the sum of set(s) of offers is less than the settlement value or, in an alternate embodiment, less than or equal to the settlement value, then the special purpose vehicle 200′ assembles one or more of the complete sets of contracts by individually buying contracts, via step 160. Step 160 can include the special purpose vehicle 200′ individually buying all of the contracts in the complete set(s) to assemble one or more complete sets of the contracts. However, when the special purpose vehicle 200′ already holds a portion of the complete set(s), step 160 can include the special purpose vehicle 200′ individually buying a remaining portion of a complete set(s). Thus, the special purpose vehicle 200′ assembles one or more of the complete sets of contracts by individually buying contracts in the complete set. In one embodiment, the special purpose vehicle 200′ may assemble the complete set(s) in step 160 when the sum of set(s) of offers is less than or equal to the settlement value because the special purpose vehicle 200′ may be owned by an exchange. In such a case, the exchange may make a profit based upon the exchanges which take place between the special purpose vehicle and other market participants. As a result, the exchange can make a profit even when the sum of the set(s) of offers is equal to (or in some cases, less than) the settlement value. Consequently, the special purpose vehicle 200′ may assemble the complete set even to in these cases not only to increase liquidity, but also to provide the exchange with a profit. Moreover, in an alternate embodiment, the special purpose vehicle 200′ may assemble the complete set(s) in step 160 when a loss would be incurred. This is because the special purpose vehicle 200′ may simply be used to increase liquidity. In addition, the special purpose vehicle 200′ may be taken into account transaction costs such as taxes, statutory levies or commissions in determining whether to make the trades that assemble the complete set(s) in step 160.

In addition, in a preferred embodiment, the special purpose vehicle 200′ may secure the trades at essentially a single moment in time for all of the contracts bought in step 160. The special purpose vehicle 200′ may exchange the contracts obtained in step 160 as a complete set in exchange for the settlement value. However, the exchange of the complete set is typically performed at a different time than the steps 156 and 160 because it is believed that market participants will desire to make the exchange with the special purpose vehicle 200′ when conditions opposite to steps 156 and 160, respectively, prevail. For example, it is believed that market participants will want to exchange the complete set for the settlement value when the sum of the bid prices is less than the settlement value, and vice versa. Also in a preferred embodiment, the interest income and profits obtained by the special purpose vehicle 200′ by selling individual contracts in step 156 or buying individual contracts at discount to settlement value in step 160 and exchanging the settlement value for the complete set or vice versa, respectively, are used to neutralize the interest rate effect in order to maintain the constant time value of the settlement value described in the methods 100 and 120. Note that although the method 150 is described in the context of the settlement value, the interest rate effect is also preferably taken into account. Thus, an amount less than the initial settlement value by the interest rate effect (i.e. the present value calculation) may be used in step 158 and an amount less than the initial settlement value by the interest rate effect may be used in step 154.

Thus, the special purpose vehicle 200′ can be an additional mechanism for market participants to perform transactions. The special purpose vehicle 200′ provides a mechanism for market participants to obtain the settlement value and/or the complete set of contracts. Thus, using the special purpose vehicle 200′ liquidity can be improved beyond the equilibrium established using conventional mechanisms. The special purpose vehicle 200′, like the exchange window 200, can automatically make trades based upon the complete set, the settlement value and individual bids and offers. These transactions might not be made in the absence of the methods 100, 120 and 150. Furthermore, the improvement in liquidity described above with respect to the exchange window 200 and the methods 100 and 120 could also be achieved using the special purpose vehicle 200′. In addition, the special purpose vehicle 200′ could be used to independently obtain profits by trading individual contracts. These profits could be used to fund the constant time value adjustment of the settlement value and/or provide an additional profit to the exchange or originator of the special purpose vehicle 200′. Moreover, in the case of betting, the special purpose vehicle 200′ can be used to short or long bets. Thus, participants in the betting market could utilize the special purpose vehicle 200′ to short bets. For example, the special purpose vehicle will preferably make trades when all participants are buyers (bettors), provided that the sum of bid prices is equal to or greater than the settlement value. The special purpose vehicle, rather than individual participants, would then be considered a bookmaker. As a result, the participants in the betting market would have a greater variety of transactions to choose from without being required to be a licensed bookmaker.

In addition, in accordance with the method and system described herein, different types of contracts, or orders, can be converted to a complete set of contracts. FIG. 8A depicts a high level flow chart of one embodiment of a method 250 in accordance with the present invention for converting other contracts into a complete set. The complete set of contracts is described above. For clarity, the method 250 is described in the context of betting. However, in an alternate embodiment, other financial instruments could be similarly converted. The bookmaker sets the odds prior to the method 250 commencing. Thus, it is assumed that the odds are known when the bets are converted to a complete set of contracts. In addition, it is assumed that the different outcomes are also known. Thus, a complete set would include each of the outcomes. For example, a complete set is to be formed for a horse race having five horses and the bets are on which horse wins, a complete set would include a bet to win on each of the five horses.

The total stakes for particular bets are determined based on the odds, via step 252. As described above, each bet is for a particular outcome, or contract in the complete set. In the example described above, assume that the odds are 5:1 for a particular horse and that a market participant has bet one dollar. Consequently, the stake is five dollars. The stake is the value of the contract(s) if the contract(s) held by the market participant are the winning contract. A number of contracts in the complete set and price per contract are determined for the bets based upon the stake, via step 254. Step 254 includes determining the value per contract if the contract wins, the corresponding number of contracts, and the price of the contract. The value per contract multiplied by the number of contracts held by the market participant equals the stake. In addition, the price is given by the value per contract divided by the odds. In the example above, the stake is five dollars. The exchange could decide that the contracts in the complete set are defined such that the value is one dollar per winning contract. Thus, step 254 would include dividing five dollars by one dollar per contract to give the number of contracts as five. The price per contract would be one dollar (value per contract) divided by the 5:1 (odds) for a price of twenty cents. Thus, using the method 250, bets can be converted into a complete set of contracts. One or more of the benefits of the method and system described herein can thus be achieved.

FIG. 8B depicts a high level flow chart of one embodiment of a method 260 in accordance with the present invention for converting contract orders into other financial instruments. Using the method 260, contract orders can be converted into the bet and odds format using the contract price and quantity. Thus, the method 260 can be viewed as the inverse of the method 250. The contracts are converted into a stake using the quantity and price, via step 262. Step 262 includes multiplying the number of contracts by their price and odds selected by the exchange or other organizer in order to obtain a stake. The stake is then converted into a bet and odds format using the odds, via step 264. Thus, the contracts in a complete set can be presented in a bet-odds format.

Consequently, using the methods 250 and 260, contracts in a complete set can be converted to a bet-odds format and vice versa. Information can thus be presented to market participants in either format (or both). Orders from both contract and bet formats can be combined and consolidated into one marketplace for presentation and trading.

A method and system has been disclosed for improving the liquidity of transactions. In addition to improving liquidity, additional profits could also be obtained. Software written according to the present invention is to be stored in some form of computer-readable medium, such as memory, CD-ROM or transmitted over a network, and executed by a processor. Consequently, a computer-readable medium is intended to include a computer readable signal which, for example, may be transmitted over a network. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for improving liquidity of transactions for a plurality of contracts, the method comprising the steps of:
defining a complete set including the plurality of contracts, the complete set guaranteeing at least an initial settlement value at at least one particular time, the complete set corresponding to a settlement value, the settlement value being determined based upon the initial settlement value.

2. The method of claim 1 wherein the settlement value is determined based on the initial settlement value and an interest rate effect, if necessary, wherein the interest rate effect includes an adjustment in a present value based upon an interest rate, the initial settlement value, and a time between the at least one particular time and the settlement value being determined.

3. The method of claim 1 wherein each of the plurality of contracts matures upon at least one particular event occurring and wherein the complete set corresponds to at least the settlement value regardless of whether the at least one particular event occurs for any of the plurality of contracts.

4. The method of claim 1 wherein the at least one particular time corresponds to at least a portion of the plurality of contracts maturing.

5. The method of claim 1 further comprising the step of:
allowing at least one market participant to trade the complete set for the settlement value.

6. The method of claim 5 wherein the allowing step further includes the step of:
only allowing the at least one market participant to obtain the settlement value in exchange for the complete set upon the plurality of contracts maturing.

7. The method of claim 5 wherein the allowing step further includes the step of:
allowing the at least one market participant to obtain the settlement value upon exchange of the complete set any time before the plurality of contracts mature.

8. The method of claim 5 wherein the allowing step further includes the step of:
allowing the at least one market participant to obtain the settlement value when the at least one particular event does not occur for any of the plurality of contracts.

9. The method of claim 1 further comprising the step of:
automatically notifying the at least one market participant that the complete set has been obtained.

10. The method of claim 1 further comprising the step of:
providing an exchange window for allowing at least one market participant to exchange the complete set for the settlement value.

11. The method of claim 10 wherein the exchange window is capable of making the exchange when a market for the plurality of contracts in the complete set is unavailable for the exchange.

12. The method of claim 10 wherein the exchange window providing step further includes the steps of:
providing the exchange window for allowing the at least one market participant to exchange the settlement value for the complete set.

13. The method of claim 10 wherein the exchange window provides the settlement value in at least one negotiable instrument.

14. The method of claim 13 wherein the at least one market participant includes a plurality of market participants, and wherein the at least one negotiable instrument is provided to the plurality of market participants having the complete set.

15. The method of claim 10 wherein the exchange window further allows a market participant to exchange at least one contract for a particular contract or contracts.

16. The method of claim 15 wherein the particular contract or contracts is part of the complete set.

17. The method of claim 1 further comprising the steps of:
providing a special purpose vehicle for buying and selling at least one of the plurality of contracts.

18. The method of claim 17 further comprising the step of allowing the special purpose vehicle to buy the complete set.

19. The method of claim 18 wherein the special purpose vehicle allowing step further includes the step of:
buying the complete set from at least one market participant using the special purpose vehicle based upon a sum of offers and the settlement value.

20. The method of claim 18 wherein the allowing special purpose vehicle step further includes the step of:
automatically buying the complete set from at least one market participant using the special purpose vehicle when a sum of offers for the complete set is less than or equal to the settlement value.

21. The method of claim 17 wherein the special purpose vehicle further buys the at least one of the plurality of contracts at a zero price.

22. The method of claim 17 further comprising the step of allowing the special purpose vehicle to sell the complete set.

23. The method of claim 22 wherein the special purpose vehicle allowing step further includes the step of:
selling the complete set to at least one market participant using the special purpose vehicle based upon a sum of bids and the settlement value.

24. The method of claim 22 wherein the special purpose vehicle allowing step further includes the step of:
automatically selling the complete set to at least one market participant using the special purpose vehicle when a sum of bids for the complete set is greater than or equal to the settlement value.

25. The method of claim 17 wherein the special purpose vehicle is allowed to secure trades when buying and/or selling at least one of the plurality of contracts.

26. The method of claim 1 wherein the plurality of contracts are based upon a continuous variable and wherein the complete set defining step further includes the step of:
defining a plurality of boundaries for the plurality of contracts of the continuous variable so that the plurality of contracts in the complete set share the plurality of boundaries.

27. The method of claim 26 wherein a portion of the plurality of boundaries are defined to be vertical such that only one winner can exist at each of the portion of the plurality of boundaries.

28. The method of claim 26 wherein a portion of the plurality of boundaries are defined to be vertical and more than one winner can exist at each of the portion of the plurality of boundaries.

29. The method of claim 26 wherein a portion of the plurality of boundaries are defined to have a slope such that more than one winner can exist at each of the portion of the plurality of boundaries.

30. The method of claim 26 wherein each of a portion of the plurality of boundaries are defined as a curve such that more than one winner can exist at each of the portion of the plurality of boundaries.

31. The method of claim 1 wherein the plurality of contracts include a digital call and a digital put for a particular option and wherein the complete set defining step further includes the step of:
defining a boundary between the digital call and the digital put such that the digital call and digital put add together to form a portion of the plurality of contracts in the complete set.

32. The method of claim 1 further comprising the step of:
presenting bid and offer information of the plurality of contracts to at least one market participant, the bid and offer information being provided in a matrix matching each of the plurality of contracts with any bid or offer for the each of the plurality contracts ranked in order based upon the price of the bid or offer.

33. The method of claim 1 wherein each of the plurality of contracts has a discrete outcome.

34. The method of claim 1 wherein the plurality of contracts are mutually exclusive.

35. The method of claim 1 wherein the plurality of contracts are collectively exhaustive.

36. The method of claim 1 wherein at least the complete set defining step is implemented using a computer system.

37. The method of claim 1 further comprising the step of:
converting a plurality of bets from a bet-odds format to the plurality of contracts.

38. The method of claim 1 further comprising the step of:
converting the plurality of contracts to a bet-odds format.

39. A computer-readable medium containing a program for improving liquidity of transactions for a plurality of contracts, the program including instructions for:
defining a complete set including the plurality of contracts, the complete set guaranteeing at least an initial settlement value at at least one particular time, the complete set corresponding to a settlement value, the settlement value being determined based upon the initial settlement value.

40. The computer-readable medium of claim 39 wherein the settlement value is determined based on the initial settlement value and an interest rate effect, if necessary, wherein the interest rate effect includes an adjustment in a present value based upon an interest rate, the initial settlement value, and a time between the at least one particular time and the settlement value being determined.

41. The computer-readable medium of claim 39 wherein each of the plurality of contracts matures upon at least one particular event occurring and wherein the complete set corresponds to at least the settlement value regardless of whether the at least one particular event occurs for any of the plurality of contracts.

42. The computer-readable medium of claim 39 wherein the program further includes instructions for:
providing an exchange window for allowing at least one market participant to exchange the complete set for the settlement value.

43. The computer-readable medium of claim 39 wherein the program further includes instructions for:
providing a special purpose vehicle for buying and selling at least one of the plurality of contracts.

44. A system for improving liquidity of transactions for a plurality of contracts, the system comprising:
means for defining a complete set including the plurality of contracts, the complete set guaranteeing at least an initial settlement at at least one particular time, the complete set corresponding to a settlement value, the settlement value being determined based upon the initial settlement value.

45. The system of claim 44 wherein the settlement value is determined based on the initial settlement value and an interest rate effect, wherein the interest rate effect includes an adjustment in a present value based upon an interest rate, the initial settlement value, and a time between the at least one particular time and the settlement value being determined.

46. The system of claim 44 wherein each of the plurality of contracts mature upon at least one particular event occurring and wherein the complete set corresponds to at least the settlement value regardless of whether the at least one particular even occurs for any of the plurality of contracts.

47. The system of claim 44 further comprising:
an exchange window for allowing at least one market participant set to trade the settlement value for the complete set.

48. The system of claim 44 wherein the exchange window is capable of making the exchange when a market for the plurality of contracts in the complete set is unavailable for the exchange.

49. A system for improving liquidity of transactions for a plurality of contracts, the system comprising:
means for defining a complete set including the plurality of contracts, the complete set guaranteeing at least an initial settlement at at least one particular time, the complete set corresponding to a settlement value, the settlement value being determined based upon the initial settlement value; and
a special purpose vehicle for buying and selling at least one of the plurality of contracts.

50. The system of claim 49 wherein the settlement value is determined based on the initial settlement value and an interest rate effect, wherein the interest rate effect includes an adjustment in a present value based upon an interest rate, the initial settlement value, and a time between the at least one particular time and the settlement value being determined.

51. The system of claim 49 wherein each of the plurality of contracts maturing upon at least one particular event occurring and wherein the complete set corresponds to at least the settlement value regardless of whether the at least one particular even occurs for any of the plurality of contracts.

52. The system of claim 49 further wherein special purpose vehicle further automatically buys the complete set from at least one market participant using the special purpose vehicle when a sum of offers for the complete set is less than the settlement value.

53. The system of claim 49 wherein the special purpose vehicle can further buy the at least one of the plurality of contracts at a zero price.

54. The system of claim 49 wherein the special purpose vehicle can further sell the complete set.

55. The system of claim 49 wherein the special purpose vehicle is further capable of selling the complete set from at least one market participant based upon a sum of bids and the settlement value.

56. The system of claim 49 wherein the special purpose vehicle can further automatically sell the complete set to at least one market participant when a sum of bids for the complete set is greater than the settlement value.

57. The system of 49 wherein the special purpose vehicle further secures trades when buying and/or selling at least one of the plurality of contracts.
